(19) United States
(12) Patent Application Publication
(10) Pub. No.: US 2025/0147756 A1
(43) Pub. Date: May 8, 2025

(54) COMPUTER SYSTEM AND INFRASTRUCTURE OPERATION HISTORY MANAGEMENT METHOD

(71) Applicant: Hitachi, Ltd., Tokyo (JP)

(72) Inventors: Kenta MASAKI, Tokyo (JP); Tomohiro Kawaguchi, Tokyo (JP)

(21) Appl. No.: 18/591,528

(22) Filed: Feb. 29, 2024

(30) Foreign Application Priority Data
Nov. 2, 2023 (JP) 2023-188758

(51) Int. Cl. G06F 8/71

(52) U.S. Cl. CPC G06F 8/71

(57) ABSTRACT

A computer system is connected to an infrastructure, a version management system, and an infrastructure management system. The infrastructure provides resources for implementing a service. The version management system manages a version of a manifest file describing settings for building the service. The infrastructure management system generates a command for the infrastructure according to the manifest file, and outputs the generated command to the infrastructure. When the manifest file is updated, the computer system receives a notification including a change ID corresponding to the version of the manifest file from the version management system, and transmits an execution instruction including the change ID for performing a change operation to the infrastructure management system so as to store an operation history of the change operation that is associated with the command and the change ID.

### CLAIM OF PRIORITY

The present application claims priority from Japanese patent application JP 2023-188758 filed on Nov. 2, 2023, the content of which is hereby incorporated by reference into this application.

### BACKGROUND OF THE INVENTION

### 1. Field of the Invention

The present invention relates to a technology for managing the operation history of a system that manages an infrastructure by using Infrastructure as Code (IaC).

### 2. Description of the Related Art

In recent years, use of cloud systems has expanded to support business agility. Further, usage patterns that combine a plurality of infrastructures such as on-premises systems and cloud systems are also increasing.

Since a configuration of an infrastructure frequently changes, it is important to understand the configuration of the infrastructure. A technology described in WO 2016/103422 has been known as a technology for presenting information regarding configurations of infrastructures.

According to WO 2016/103422, provided is a cloud service provision system that is able to understand a configuration history of a cloud environment. Consequently, the cloud service provision system includes a cloud connection information reception section, a configuration storage processing section, a configuration history display processing section, a cloud connection information reception section, a cloud connection information database (DB), a configuration information acquisition processing section, a cloud configuration history DB, and a configuration history acquisition processing unit. Cloud connection information is acquired by use of the cloud identification (ID) of a user. The cloud service provision system acquiring cloud configuration information from the acquired cloud connection information is identified. The cloud configuration information is acquired and stored in the cloud configuration history DB. On the basis of cloud information that is received from the user to display a configuration, the configuration history is acquired from the cloud configuration history DB to generate and display a configuration diagram with a component element icon for each component element.

### SUMMARY OF THE INVENTION

IaC is known as a technology for providing support for building a service on an infrastructure. The user can automatically build a service on an infrastructure by inputting a manifest file to an IaC tool. Settings for building the service are written as code in the manifest file. In the following description, the manifest file is referred to as the manifest.

The IaC tool generates commands that are executable on an infrastructure to implement the contents of the manifest. The user cannot understand the commands (the contents of an operation) executed by the IaC tool. Therefore, there is a problem in that it is not possible to verify a case, for example, where a failure has occurred.

The present invention has been made to provide a technology for understanding the contents of IaC tool operations based on the manifest.

According to a representative aspect of the present invention disclosed in this application, there is provided a computer system that is connected to an infrastructure, a version management system, and an infrastructure management system. The infrastructure provides resources for implementing a service. The version management system manages the version of a manifest file describing the settings for building the service. The infrastructure management system generates a command for the infrastructure in accordance with the manifest file, and outputs the generated command to the infrastructure. When the manifest file is updated, the computer system receives a notification including a change ID corresponding to the version of the manifest file from the version management system, and transmits an execution instruction including the change ID for performing a change operation to the infrastructure management system so as to store an operation history of change operation that is associated with the command and the change ID.

According to the technology provided by the present invention, it is possible to understand the contents of operation of the infrastructure management system (IaC tool) because the operation history of the change operation can be stored in association with the change ID. Problems, configurations, and advantages other than those described above will become apparent from the following description of embodiments.

### BRIEF DESCRIPTION OF THE DRAWINGS

FIG. 1 is a diagram illustrating an example of a configuration of a system according to a first embodiment;

FIG. 2 is a diagram illustrating an example of a configuration of a service in the first embodiment;

FIG. 3 is a diagram illustrating an example of a manifest in the first embodiment;

FIG. 4 is a diagram illustrating an example of a data structure of object state information in the first embodiment;

FIG. 5 is a sequence diagram illustrating a flow of processing performed upon manifest update of a storage service in the system according to the first embodiment;

FIG. 6 is a diagram illustrating an example of a command transmitted to an infrastructure in the first embodiment;

FIG. 7 is a diagram illustrating an example of a data structure of an operation history DB in the first embodiment;

FIG. 8 is a flowchart illustrating an example of an exclusive control process that is performed by an object state management section in the first embodiment;

FIG. 9A is a diagram illustrating an example of object state information change in the exclusive control process in the first embodiment;

FIG. 9B is a diagram illustrating an example of object state information change in the exclusive control process in the first embodiment;

FIG. 9C is a diagram illustrating an example of object state information change in the exclusive control process in the first embodiment;

FIG. 9D is a diagram illustrating an example of object state information change in the exclusive control process in the first embodiment;

FIG. 9E is a diagram illustrating an example of object state information change in the exclusive control process in the first embodiment;

FIG. 10 is a sequence diagram illustrating a flow of processing performed upon the manifest update of the storage service in the system according to the first embodiment;

FIG. 11 is a diagram illustrating an example of a data structure of configuration information in the first embodiment;

FIG. 12 is a sequence diagram illustrating a flow of processing performed to acquire an operation history in the system according to the first embodiment;

FIG. 13 is a flowchart illustrating an example of an operation history extraction process that is performed by an operation history extraction section in the first embodiment;

FIG. 14 is a flowchart illustrating an example of the operation history extraction process that is performed by the operation history extraction section in the first embodiment;

FIG. 15 is a diagram illustrating an example of a data structure of extracted information that is generated by the operation history extraction section in the first embodiment;

FIG. 16 is a flowchart illustrating an example of a display information generation process that is performed by a configuration diagram generation section in the first embodiment; and

FIG. 17 is a diagram illustrating an example of a screen that is displayed on a user terminal in the first embodiment.

### DESCRIPTION OF THE PREFERRED EMBODIMENTS

Embodiments of the present invention will now be described with reference to the accompanying drawings. However, the present invention should not be construed as being limited to the following description of the embodiments. A person skilled in the art will readily understand that the specific configuration of the present invention can be changed without departing from the spirit and idea of the present invention.

Component elements and functions identical or similar to those described in conjunction with the following-described configuration of the present invention are designated by the same reference signs as the corresponding ones in order to avoid redundant description.

In this document, expressions such as “first,” “second,” and “third” are used to identify component elements. However, such expressions do not necessarily restrict the number or sequence of the component elements.

### First Embodiment

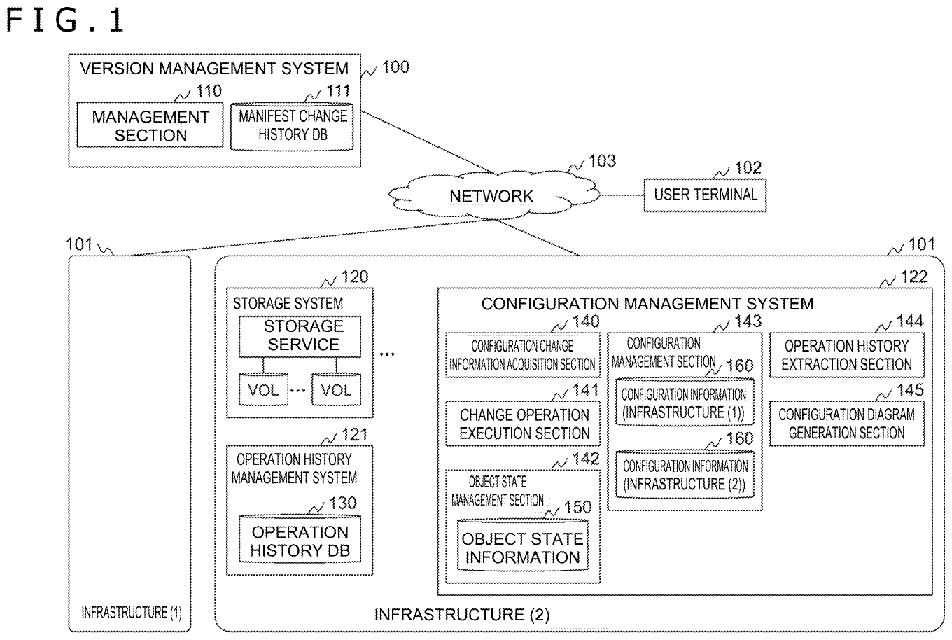

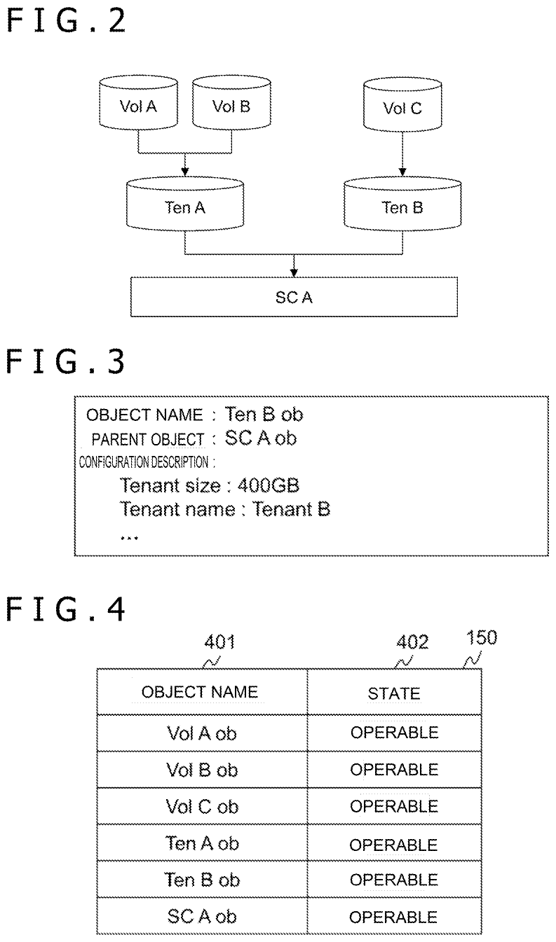

FIG. 1 is a diagram illustrating an example of a configuration of a system according to a first embodiment. FIG. 2 is a diagram illustrating an example of a configuration of a service in the first embodiment. FIG. 3 is a diagram illustrating an example of a manifest in the first embodiment.

The system includes a version management system 100, a plurality of infrastructures 101, and a user terminal 102. The version management system 100, the plurality of infrastructures 101, and the user terminal 102 are connected through a network 103 such as a local area network (LAN). It should be noted that the connection method adopted by the network 103 may be either wired or wireless.

The version management system 100 manages the manifest and the version of the manifest. The version management system 100 includes a management section 110, and retains a manifest change history database (DB) 111. The management section 110 manages the manifest. For example, the management section 110 receives the manifest from the user terminal 102, adds identification information (a change ID) corresponding to the version to the manifest, and stores the manifest in the manifest change history DB 111. Further, the management section 110 checks for changes between the received manifest and a registered manifest. If there is any change, the management section 110 transmits configuration change information to the infrastructures 101.

The infrastructures 101 are systems that provide resources for implementing services. The infrastructures 101 may be either on-premises infrastructures or cloud infrastructures. The present embodiment will be described on the assumption that the infrastructures 101 provide resources for implementing storage services configured to provide volumes. The infrastructures 101 each include a storage system 120 that provides resources. There may be two or more storage systems 120. Further, the infrastructures 101 each include an operation history management system 121 and a configuration management system 122.

The operation history management system 121 manages the operation history of operations on the infrastructure 101. The operation history management system 121 retains an operation history DB 130.

The configuration management system 122 changes and manages the configuration of a storage service. The configuration management system 122 includes various functional sections, namely, modules, such as a configuration change information acquisition section 140, a change operation execution section 141, an object state management section 142, a configuration management section 143, an operation history extraction section 144, and a configuration diagram generation section 145.

The configuration management section 143 manages the configuration of the storage service. The configuration management section 143 manages configuration information 160. As depicted in FIG. 2, the storage service includes a plurality of component elements (objects). “Vol” is an object that corresponds to a volume provided to a user. “Ten” is an object that corresponds to a storage pool configured to generate a volume. “SC” is an object that corresponds to a cluster including a plurality of drives. As depicted in FIG. 2, the objects have a hierarchical structure, and there are dependencies between the hierarchically structured objects. In the present embodiment, it is assumed that the manifest depicted in FIG. 3 is defined for each object.

The object state management section 142 manages the operational states of objects included in the storage service. The object state management section 142 manages object state information 150. The object state information 150 is generated when the storage service is constructed and is updated when the manifest is updated.

The configuration change information acquisition section 140 acquires the configuration change information from the version management system 100. The change operation execution section 141 is a functional section corresponding to an IaC tool, generates a command according to the manifest, and outputs the generated command to the infrastructure 101.

The operation history extraction section 144 extracts the operation history. The configuration diagram generation section 145 generates a diagram (configuration diagram) that depicts the object configuration of the storage service at a certain point of time.

It should be noted that the operation history management system 121 of at least one infrastructure 101 may manage the operation histories of all infrastructures 101. Further, the configuration management system 122 of at least one infrastructure 101 may manage the configurations of all infrastructures 101.

It should be noted that the operation history management system 121 and the configuration management system 122 may not necessarily be included in the infrastructure 101.

It should also be noted that the functional sections of the configuration management system 122 may be integrated into a single functional section. Further, one functional section may be divided into a plurality of functional sections for every function.

It should further be noted that the configuration management system 122 may not necessarily include the change operation execution section 141. In the case where the configuration management system 122 does not include the change operation execution section 141, the change operation execution section 141 is included in the infrastructure 101 or in another system.

FIG. 4 is a diagram illustrating an example of a data structure of the object state information 150 in the first embodiment.

Entries each including an object name 401 and a state 402 are stored as the object state information 150. One entry exists for one object. The state 402 is the information stored to indicate whether a change operation can be performed on an object corresponding to the object name 401. If the change operation can be performed on the object, “operable” is stored, and if the change operation cannot be performed on the object, “inoperable” is stored.

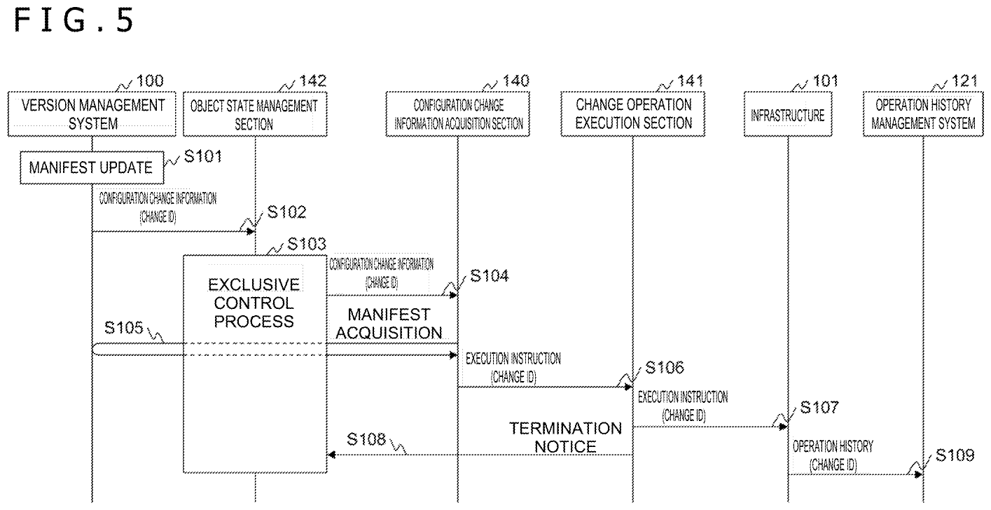

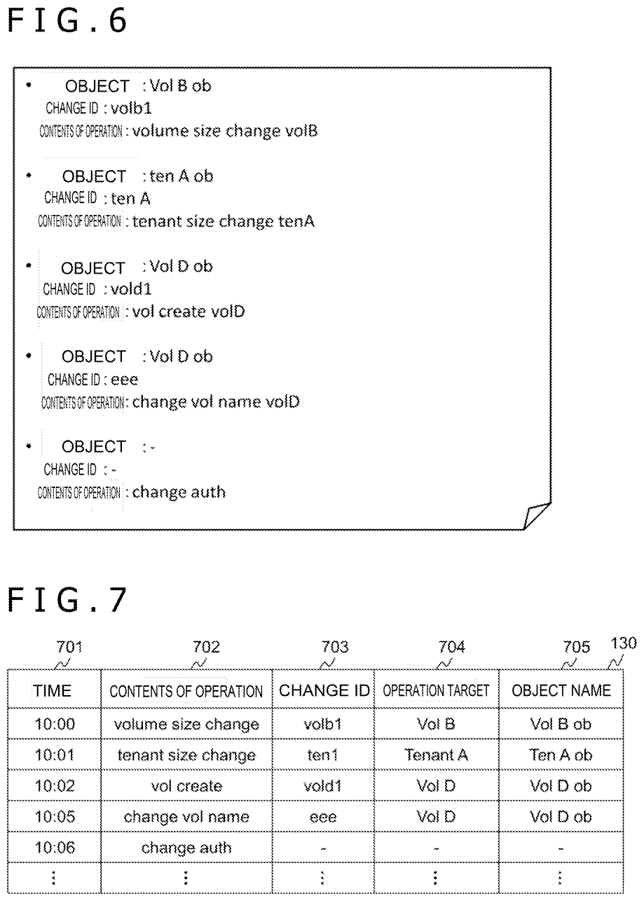

First, a method for acquiring the operation history of change operation associated with a manifest update will be described. FIG. 5 is a sequence diagram illustrating a flow of processing performed upon the manifest update of the storage service in the system according to the first embodiment. FIG. 6 is a diagram illustrating an example of a command transmitted to the infrastructure 101 in the first embodiment. FIG. 7 is a diagram illustrating an example of a data structure of the operation history DB 130 in the first embodiment.

Upon receiving an updated manifest (step S101), the version management system 100 transmits the configuration change information including a change ID corresponding to the version of the manifest to the object state management section 142 (step S102). The configuration change information additionally includes the object name.

The object state management section 142 performs an exclusive control process to control the execution of a change operation on the object corresponding to the updated manifest (step S103). If the change operation is executable, the object state management section 142 transmits the configuration change information together with the change ID to the configuration change information acquisition section 140 (step S104).

The configuration change information acquisition section 140 acquires the updated manifest from the version management system 100 (step S105), and transmits an execution instruction together with the change ID and the manifest to the change operation execution section 141 (step S106).

The change operation execution section 141 generates a command according to the manifest, and transmits the command together with the change ID to the infrastructure 101 (step S107). Further, the change operation execution section 141 transmits a termination notice to the object state management section 142 (step S108).

After performing the change operation according to the command, the infrastructure 101 transmits, to the operation history management system 121, the operation history that includes the contents of the change operation based on the change ID and on the command (step S109).

For example, when the command depicted in FIG. 6 is executed, the operation history DB 130 of the operation history management system 121 stores the operation history depicted in FIG. 7.

The operation history DB 130 stores entries each including time 701, the contents of operation 702, a change ID 703, an operation target 704, and an object name 705. It should be noted that the fields included in the entries are merely examples and are not limited to those depicted in FIG. 7.

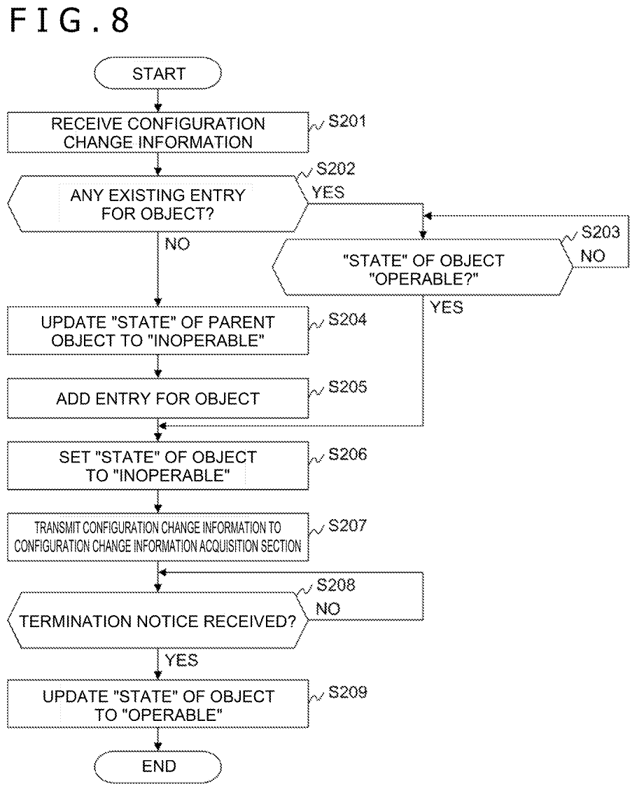

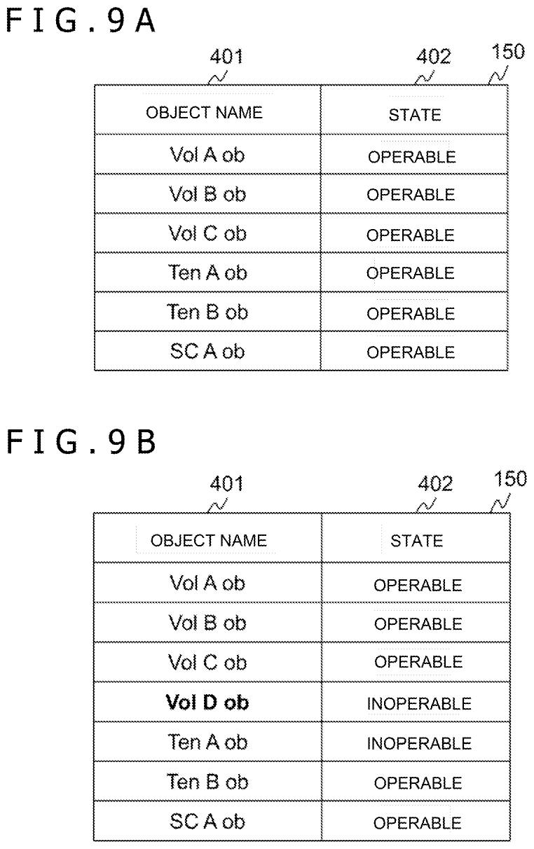

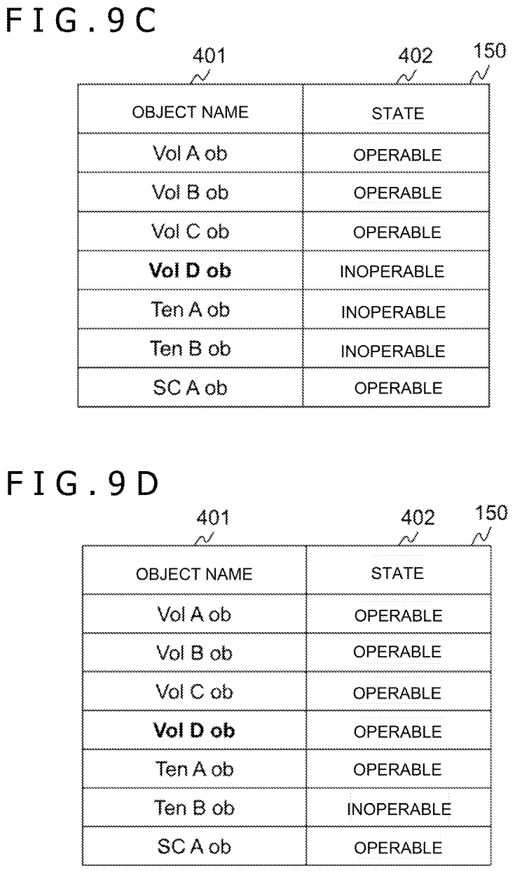

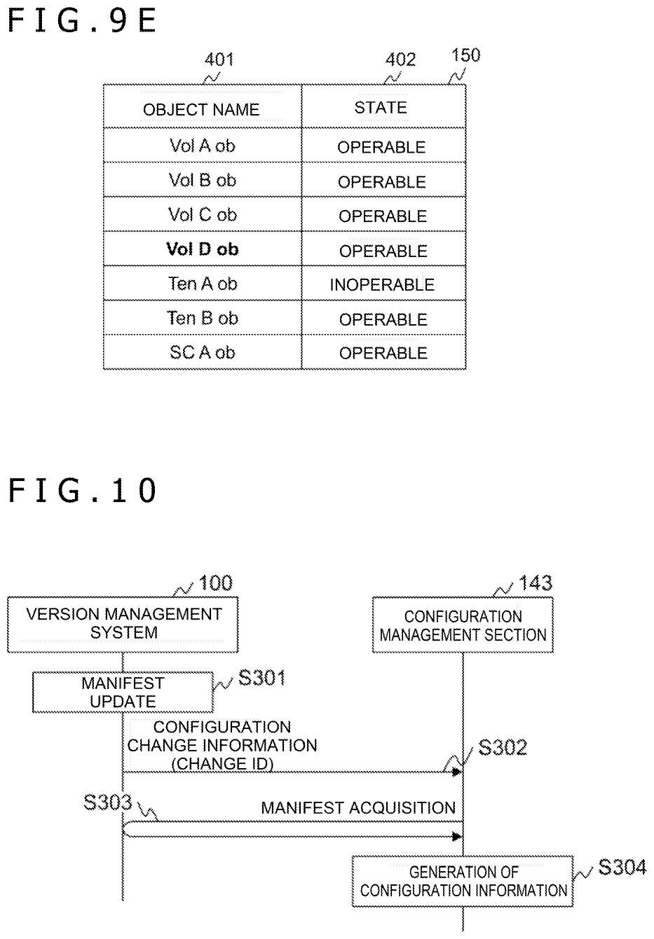

FIG. 8 is a flowchart illustrating an example of the exclusive control process that is performed by the object state management section 142 in the first embodiment. FIGS. 9A, 9B, 9C, 9D, and 9E are diagrams illustrating the examples of changes in the object state information 150 in the exclusive control process of the first embodiment.

Upon receiving the configuration change information (step S201), the object state management section 142 references the object state information 150, and determines whether there is an entry for an object to be operated (step S202).

If the object state information 150 includes an entry for the object to be operated, the object state management section 142 determines whether the state 402 of the object is “operable” (step S203).

If the state 402 of the object is not “operable,” the object state management section 142 returns to step S203 after the lapse of a certain period of time. If the state 402 of the object is “operable,” the object state management section 142 proceeds to step S206.

If it is determined in step S202 that the object state information 150 does not include an entry for the object to be operated, the object state management section 142 updates the state 402 of a parent object of the object to “inoperable” (step S204), and adds an entry for the object to the object state information 150 (step S205). Subsequently, the object state management section 142 proceeds to step S206.

In step S205, the object state management section 142 adds an entry to the object state information 150, and sets the name of the object to be operated as the object name 401 of the added entry.

In step S206, the object state management section 142 updates the state 402 of the object to be operated to “inoperable” (step S206).

The object state management section 142 transmits the configuration change information to the configuration change information acquisition section 140 (step S207). The processing in step S207 corresponds to the processing in step S104. Subsequently, the object state management section 142 monitors the termination notice.

The object state management section 142 determines whether the termination notice is received (step S208).

If the termination notice is not received, the object state management section 142 returns to step S208 after the lapse of a certain period of time.

If the termination notice is received, the object state management section 142 updates the state 402 of the object to be operated to “operable” (step S209). It should be noted that, if the state 402 of the parent object has also been updated, the object state management section 142 also updates the state 402 of the parent object to “operable.”

It should be noted that, although the number of hierarchical levels requiring exclusive control is assumed to be one, the number of exclusively controlled hierarchical levels may be changed according to the contents of operation.

The exclusive control process will now be described with reference to a specific example. Here, it is assumed that the object state information 150 is in a state depicted in FIG. 9A.

In a case where the manifest (first manifest) for adding the volume “Vol D” from the storage pool “Ten A” is first added, the object state management section 142 updates the state 402 of the parent object “Ten A” to “inoperable” (step S204). Further, the object state management section 142 adds an entry for the object “Vol D” (step S205), and sets the state 402 to “inoperable” (step S206).

As a result of the above processing, the object state information 150 is put in a state depicted in FIG. 9B.

Now, it is assumed that, before the receipt of the termination notice regarding the first manifest, the manifest (second manifest) for expanding the storage pool “Ten A” and the manifest (third manifest) for expanding the storage pool “Ten B” have been added. As regards the second manifest, since the state 402 of the object “Ten A” is “inoperable,” the object state management section 142 waits until the state 402 of the object “Ten A” becomes “operable” (step S203). As regards the third manifest, since the state 402 of the object “Ten B” is “operable,” the object state management section 142 updates the state 402 to “inoperable” (step S206).

As a result of the above processing, the object state information 150 is put in a state depicted in FIG. 9C.

As described above, object change operations requiring no exclusive control are performed in parallel. Meanwhile, object change operations requiring exclusive control are controlled in such a manner that they are not performed in parallel.

If the termination notice regarding the first manifest is received, the object state management section 142 updates the states 402 of the objects “Ten A” and “Vol D” to “operable” (step S209).

As a result of the above processing, the object state information 150 is put in a state depicted in FIG. 9D.

As regards the second manifest, since the state 402 of the object “Ten A” has become “operable,” the object state management section 142 updates the state 402 of the object “Ten A” to “inoperable” (step S206). Further, if the termination notice regarding the third manifest is received, the object state management section 142 updates the state 402 of the object “Ten B” to “operable” (step S209).

As a result of the above processing, the object state information 150 is put in a state depicted in FIG. 9E.

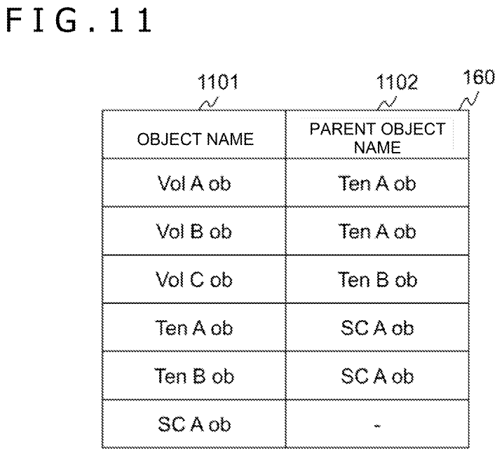

FIG. 10 is a sequence diagram illustrating a flow of processing performed upon the manifest update of the storage service in the system according to the first embodiment. FIG. 11 is a diagram illustrating an example of a data structure of the configuration information 160 in the first embodiment.

The processing depicted in FIG. 10 is performed in parallel with the processing depicted in FIG. 5.

When the manifest is updated (step S301), the version management system 100 transmits the configuration change information to the configuration management section 143 (step S302).

The configuration management section 143 acquires the updated manifest and the manifest of a related object from the version management system 100 (step S303). It should be noted that the manifest of the related object can be acquired by performing a search according to the name of the parent object included in the updated manifest.

The configuration management section 143 generates the configuration information 160 according to the acquired manifests (step S304).

Entries each including an object name 1101 and a parent object name 1102 are stored as the configuration information 160. One entry exists for one object. It should be noted that the fields included in the entries are merely examples and are not limited to those depicted in FIG. 11.

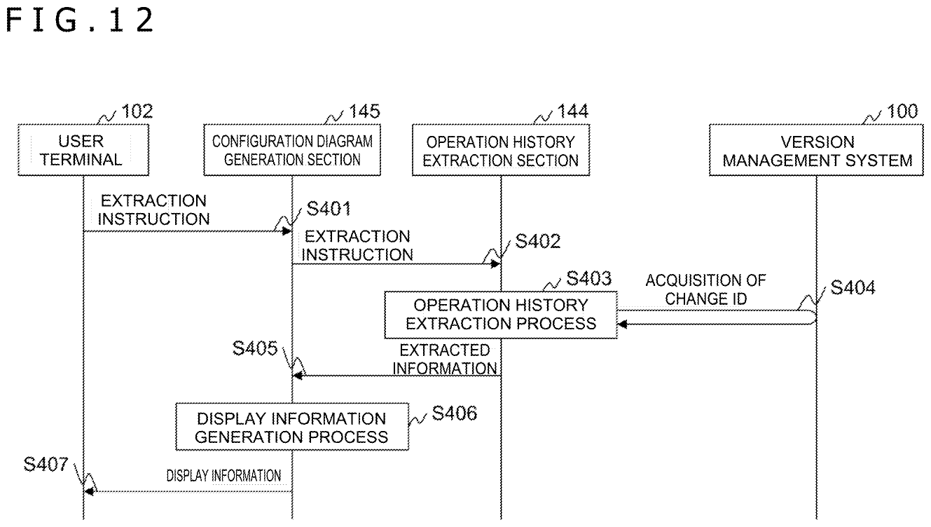

A method for acquiring the operation history of operations performed to change the configuration of the storage service will be described. FIG. 12 is a sequence diagram illustrating a flow of processing performed to acquire the operation history in the system according to the first embodiment.

The user transmits an extraction instruction to the configuration diagram generation section 145 by use of the user terminal 102 (step S401). The extraction instruction includes the object name and the information specifying the range of operation history acquisition. Possible methods for specifying the range of operation history acquisition include a method of specifying a set of change IDs and a method of specifying a time range.

The configuration diagram generation section 145 transfers the received extraction instruction to the operation history extraction section 144 (step S402).

Upon receiving the extraction instruction, the operation history extraction section 144 performs an operation history extraction process (step S403). In the operation history extraction process, the operation history extraction section 144 accesses the version management system 100 as needed and acquires a change ID (step S404).

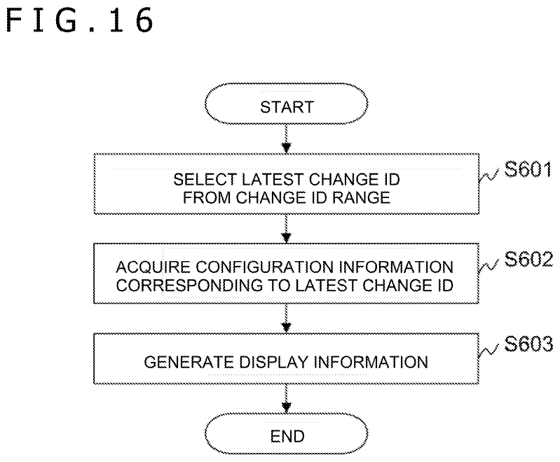

The operation history extraction section 144 transmits extracted information 1500 (see FIG. 15) for the storage of an extraction result to the configuration diagram generation section 145 (step S405).

The configuration diagram generation section 145 performs a display information generation process to display the extraction result (step S406). The configuration diagram generation section 145 transmits display information to the user terminal 102 (step S407).

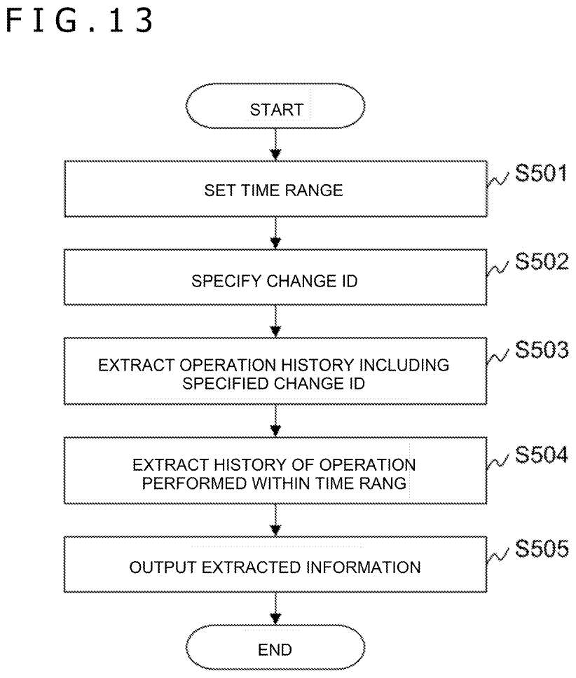

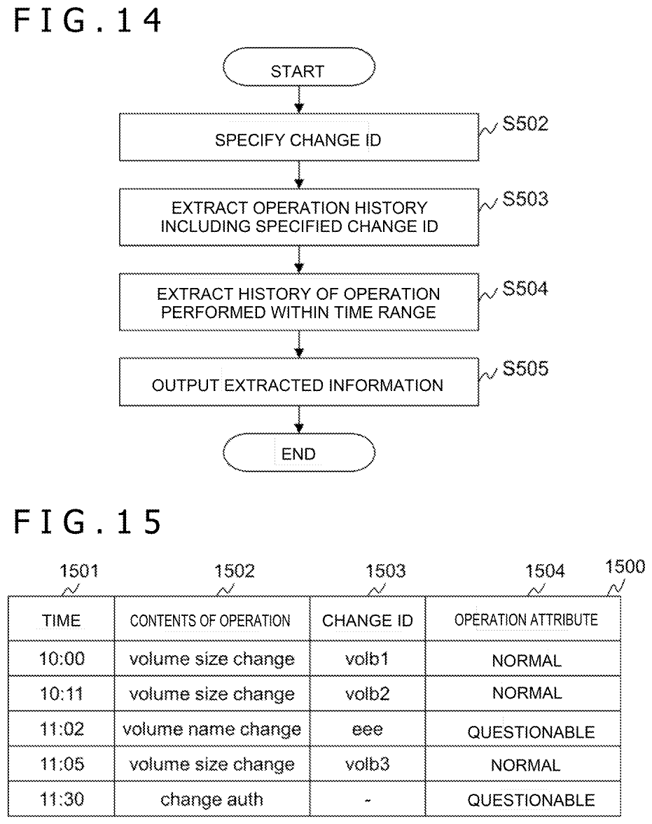

FIGS. 13 and 14 are flowcharts illustrating examples of the operation history extraction process that is performed by the operation history extraction section 144 in the first embodiment. FIG. 15 is a diagram illustrating an example of a data structure of the extracted information 1500 that is generated by the operation history extraction section 144 in the first embodiment.

FIG. 13 depicts the operation history extraction process that is performed when a set of change IDs is specified. FIG. 14 depicts the operation history extraction process that is performed when the time range is specified.

First, the extracted information 1500 will be described. The extracted information 1500 is used for the storage of the extracted operation history. The extracted information 1500 includes time 1501, the contents of operation 1502, a change ID 1503, and an operation attribute 1504. The time 1501, the contents of operation 1502, and the change ID 1503 are the same fields as the time 701, the contents of operation 702, and the change ID 703. The operation attribute 1504 is a field that stores information indicating whether the operation history indicates a change operation performed by a command generated according to the manifest. If the operation history indicates a change operation performed by a command generated according to the manifest, “normal” is stored. Meanwhile, if the operation history does not indicate a change operation performed by a command generated according to the manifest, “questionable” is stored.

First, the operation history extraction process depicted in FIG. 13 will be described.

The operation history extraction section 144 accesses the version management system 100 according to the set of change IDs, and sets the time range (step S501).

More specifically, the operation history extraction section 144 acquires the registration time of the manifest for each change ID included in the set of change IDs, and sets the time range determined by the two registration times.

The operation history extraction section 144 accesses the version management system 100 according to the time range, and identifies the change ID to be processed (step S502).

More specifically, the operation history extraction section 144 identifies the manifest whose registration time of the target object falls within the determined time range, and acquires the change ID of the identified manifest.

The operation history extraction section 144 extracts the operation history including the specified change ID from the operation history DB 130 (step S503). The operation history extraction section 144 registers the extracted operation history as the extracted information 1500. In this instance, “normal” is set as the operation attribute 1504.

The operation history extraction section 144 extracts the operation history of operations performed on the target object within the time range in such a manner that the extracted operation history does not include a change ID or includes a change ID other than the specified change ID (step S504). The operation history extraction section 144 registers the extracted operation history as the extracted information 1500. In this instance, “questionable” is set as the operation attribute 1504.

The operation history extraction section 144 sorts the operation history of the extracted information 1500 in chronological order, and outputs the result of sorting (step S505).

It should be noted that step S504 need not necessarily be performed. In the case where step S504 is skipped, only the operation history including the specified change ID is extracted.

The operation history extraction process depicted in FIG. 14 will now be described. The operation history extraction process depicted in FIG. 14 does not include step S501. In step S502, the change ID to be processed is specified by the operation history extraction section 144 according to the specified time range. The other processing steps are the same as those described with reference to FIG. 13.

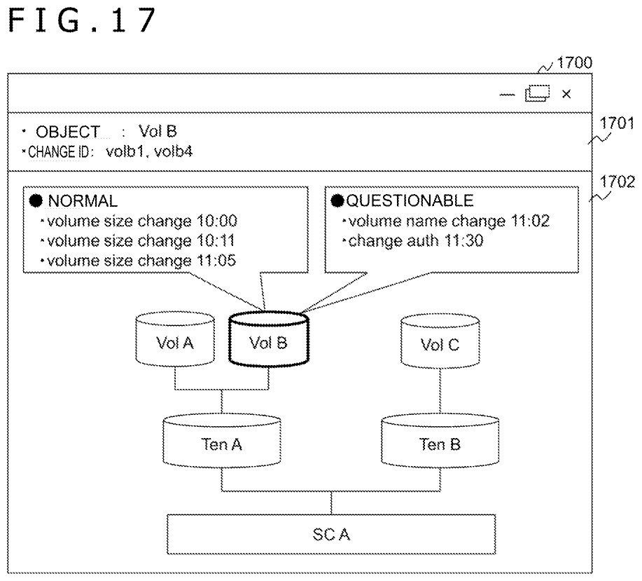

FIG. 16 is a flowchart illustrating an example of the display information generation process that is performed by the configuration diagram generation section 145 in the first embodiment. FIG. 17 is a diagram illustrating an example of a screen that is displayed on the user terminal 102 in the first embodiment.

The configuration diagram generation section 145 references the extracted information 1500, and identifies the latest change ID (step S601). More specifically, the configuration diagram generation section 145 performs a search to retrieve an entry whose change ID is stored in the change ID 1503 and whose operation attribute 1504 is “normal,” and identifies the latest change ID according to the time 1501 of the retrieved entry.

The configuration diagram generation section 145 acquires the configuration information 160 corresponding to the latest change ID (step S602).

The configuration diagram generation section 145 generates the display information by use of the extracted information 1500 and the configuration information 160 (step S603). For example, the configuration diagram generation section 145 generates the configuration diagram that visualizes the object configuration of the storage service according to the configuration information 160, and generates the display information for displaying the extracted information 1500 superimposed on the configuration diagram.

A screen 1700 depicted, for example, in FIG. 17 is displayed on the user terminal 102 according to the display information. The screen 1700 includes display areas 1701 and 1702. The display area 1701 is used to display information regarding the extraction instruction. The display area 1702 is used to display the configuration of the object and the result of extraction of the operation history.

According to the technology provided by the present invention, the operation history of change operation according to a manifest update can be managed in such a manner as to distinguish it from another operation history. Since the operation history of the change operation can be extracted according to the change ID, the change operation performed by the change operation execution section 141 can be understood in detail. Further, extracting the operation history of another operation at the time of execution of the change operation makes it possible, for example, to verify the change operation and check for an unauthorized operation.

It should be noted that the present invention is not limited to the foregoing embodiment, but extends to various modifications. Further, for example, the configuration of the foregoing embodiment has been described in detail in order to facilitate the understanding of the present invention, and the present invention is not necessarily limited to a configuration that includes all the above-described component elements. Further, some component elements of individual embodiments may be added to, deleted from, or replaced with other component elements.

Moreover, for example, the above-described component elements, functions, processing sections, and processing units may be partly or wholly implemented by hardware, that is, for example, by appropriately designing integrated circuits. Additionally, the technology provided by the present invention can also be implemented by a program code of software that implements the functions of the embodiments. In the case where the program code is used for function implementation, a storage medium on which the program code is recorded is provided to a computer, and a processor included in the computer reads the program code stored on the storage medium. In this case, the program code itself which is read from the storage medium implements the above-described functions of the embodiments, and the program code itself and the storage medium storing the program code constitute the present invention. Storage media for supplying the program code include, for example, a flexible disk, a compact disc (CD)-read-only memory (ROM), a digital versatile disk (DVD)-ROM, a hard disk, a solid-state drive (SSD), an optical disk, a magneto-optical disk, a CD-R, a magnetic tape, a non-volatile memory card, and a ROM.

Further, the program code for achieving the functions described in conjunction with the foregoing embodiment can be implemented by a wide range of programs or script languages such as an assembler, C/C++, Perl, Shell, PHP, Python, and Java (registered trademark).

Furthermore, the program code of software implementing the functions of the embodiments may be distributed through a network, stored on a storage unit of the computer, such as a hard disk or a memory, or on a storage medium such as a CD-RW or a CD-R, and read out and executed by the processor included in the computer.

Control lines and information lines considered necessary for explanation are depicted in conjunction with the foregoing embodiment, and all the control lines and information lines required for a product are not necessarily depicted. All component elements may be interconnected.

What is claimed is:

1. A computer system that is connected to an infrastructure, a version management system, and an infrastructure management system,
wherein the infrastructure provides resources for implementing a service,
the version management system manages a version of a manifest file describing settings for building the service,
the infrastructure management system generates a command for the infrastructure according to the manifest file, and outputs the generated command to the infrastructure, and
when the manifest file is updated, the computer system receives a notification including a change identification corresponding to the version of the manifest file from the version management system, and transmits an execution instruction including the change identification for performing a change operation to the infrastructure management system so as to store an operation history of the change operation that is associated with the command and the change identification.

2. The computer system according to claim 1,
wherein the computer system is connected to gain access to a database that stores an operation history of operations performed by the infrastructure, and
when an output instruction for outputting the operation history of the change operation according to the update of the manifest file is received, the computer system extracts the operation history associated with the change identification from the database, and outputs the extracted operation history.

3. The computer system according to claim 2,
wherein the service includes a plurality of objects,
the plurality of objects have a hierarchical structure,
dependencies exist between the objects at different hierarchical levels,
the manifest file exists for each of the objects,
when the notification is received, the computer system determines whether exclusive control needs to be provided for an object to be changed upon the update of the manifest file and for an object dependent upon the object to be changed upon the update of the manifest file, and
when the computer system determines that exclusive control does not need to be provided for the object to be changed upon the update of the manifest file and for the object dependent upon the object to be changed upon the update of the manifest file, the computer system transmits an execution instruction for performing the change operation.

4. The computer system according to claim 3,
wherein the operation history is data including fields for storing time, contents of operation, the object to be operated, and the change identification,
the output instruction includes identification information regarding the object and two change identifications, and
the computer system
accesses the version management system and identifies registration times of the manifest file corresponding to the two change identifications included in the output instruction,
acquires the change identification of the manifest file that indicates the object specified by the output instruction and has a registration time included in a time range determined by the two identified registration times, and
extracts, from the database, the operation history that includes either the change identification included in the output instruction or the change identification acquired from the version management system.

5. The computer system according to claim 4,
wherein the computer system extracts, from the database, the operation history that relates to the object specified by the output instruction, that has the registration time included in the time range, and that does not include the change identification or includes the change identification different from the change identification included in the output instruction and from the change identification acquired from the version management system.

6. The computer system according to claim 3,
wherein the operation history is data including fields for storing time, contents of operation, the object to be operated, and the change identification,
the output instruction includes identification information regarding the object and a time range;
the computer system
accesses the version management system and acquires the change identification of the manifest file that relates to the object specified by the output instruction and has a registration time included in the time range, and
extracts, from the database, the operation history that includes one of the change identifications acquired from the version management system.

7. The computer system according to claim 6,
wherein the computer system extracts, from the database, the operation history that has the registration time included in the time range and that does not include the change identification or includes the change identification different from the change identification acquired from the version management system.

8. The computer system according to claim 3,
wherein, when the notification is received, the computer system
accesses the version management system, acquires the updated manifest file, and acquires the manifest file of another object included in the service including the object corresponding to the updated manifest file, and
generates configuration information indicating a configuration of the object included in the service by using the plurality of acquired manifest files, and stores the configuration information in association with the change identification, and
when the output instruction is received, the computer system
identifies a latest one of a plurality of the change identifications, and
generates the configuration information associable with the identified change identification and display information for displaying the extracted operation history, and outputs the generated information.

9. An infrastructure operation history management method executed by a computer system that is connected to an infrastructure, a version management system, and an infrastructure management system, the infrastructure providing resources for implementing a service, the version management system managing a version of a manifest file describing settings for building the service, the infrastructure management system generating a command for the infrastructure according to the manifest file and outputting the generated command to the infrastructure, the infrastructure operation history management method comprising:
a first step of causing the computer system to receive a notification including a change identification corresponding to the version of the manifest file from the version management system due to the update of the manifest file; and
a second step of causing the computer system to transmit an execution instruction including the change identification for performing a change operation to the infrastructure management system so as to store an operation history of the change operation that is associated with the command and the change identification.

10. The infrastructure operation history management method according to claim 9,
wherein the computer system is connected to gain access to a database that stores an operation history of operations performed by the infrastructure, the infrastructure operation history management method comprising:
a third step of, when an output instruction for outputting the operation history of the change operation according to the update of the manifest file is received, causing the computer system to extract the operation history associated with the change identification from the database and output the extracted operation history.

11. The infrastructure operation history management method according to claim 10,
wherein the service includes a plurality of objects,
the plurality of objects have a hierarchical structure,
dependencies exist between the objects at different hierarchical levels,
the manifest file exists for each of the objects, and
the second step includes
a step of causing the computer system to determine whether exclusive control needs to be provided for an object to be changed upon the update of the manifest file and for an object dependent upon the object to be changed upon the update of the manifest file, and
when the computer system determines that exclusive control does not need to be provided for the object to be changed upon the update of the manifest file and for the object dependent upon the object to be changed upon the update of the manifest file, a step of causing the computer system to transmit an execution instruction for performing the change operation.

12. The infrastructure operation history management method according to claim 11,
wherein the operation history includes data that is contained in fields for storing time, contents of operation, the object to be operated, and the change identification,
the output instruction includes identification information regarding the object and two change identifications, and
the third step includes
a step of causing the computer system to access the version management system and identify registration times of the manifest file corresponding to the two change identifications included in the output instruction,
a step of causing the computer system to acquire the change identification of the manifest file that indicates the object specified by the output instruction and has a registration time included in a time range determined by the two identified registration times,
a step of causing the computer system to extract, from the database, the operation history that includes either the change identification included in the output instruction or the change identification acquired from the version management system, and
a step of causing the computer system to extract, from the database, the operation history that relates to the object specified by the output instruction, that has the registration time included in the time range, and that does not include the change identification or includes the change identification different from the change identification included in the output instruction and different from the change identification acquired from the version management system.

13. The infrastructure operation history management method according to claim 11,
wherein the operation history includes data that is contained in fields for storing time, contents of operation, the object to be operated, and the change identification,
the output instruction includes identification information regarding the object and a time range, and
the third step includes
a step of causing the computer system to access the version management system and acquire the change identification of the manifest file relating to the object specified by the output instruction and having a registration time included in the time range,
a step of causing the computer system to extract, from the database, the operation history that includes either one of the change identifications acquired from the version management system, and
a step of causing the computer system to extract, from the database, the operation history that has the registration time included in the time range and that does not include the change identification or includes the change identification different from the change identification acquired from the version management system.

14. The infrastructure operation history management method according to claim 11,
wherein the second step includes
a step of causing the computer system to access the version management system, acquire the updated manifest file, and acquire the manifest file of another object included in the service including the object corresponding to the updated manifest file, and
a step of causing the computer system to generate configuration information indicating a configuration of the object included in the service by using the plurality of acquired manifest files, and store the configuration information in association with the change identification; and
the third step includes
a step of causing the computer system to identify a latest one of a plurality of the change identifications, and
a step of causing the computer system to generate the configuration information associable with the identified change identification and display information for displaying the extracted operation history, and output the generated information.
